(19) United States
(12) Patent Application Publication
(10) Pub. No.: US 2004/0085897 A1
(43) Pub. Date: May 6, 2004

(54) Method and apparatus for high performance single block scheduling in distributed systems

(76) Inventors: Shimshon Jacobi, Arad (IL); Yuval Yunger, Be'er Sheva (IL); Assi Mashala, Meitar (IL); Eyal Nagar, Modiin (IL); Ofer Beeri, Be'er Sheva (IL); Udi Barzilai, Meitar (IL); Tsvi Slonim, Moshav Yagel (IL)

Correspondence Address: NIXON & VANDERHYE, PC, 1100 N GLEBE ROAD, 8TH FLOOR, ARLINGTON, VA, 22201-4714, US

(21) Appl. No.: 10/293,934

(22) Filed: Nov. 14, 2002

(30) Foreign Application Priority Data
Nov. 6, 2002 (IL) 152676

(51) Int. Cl. H04J 1/16; H04J 3/14

(52) U.S. Cl. 370/229; 370/412

(57) ABSTRACT

A method for transmitting data between line cards in a distributed network switching system, through a switch fabric which is separated from said line cards, said method comprising receiving at said switch fabric information regarding queues of data packets that have arrived at said line cards and are waiting to be transmitted therefrom, recording said information at one or more databases located in said switch fabric, computing in said switch fabric a suitable array of connections between said line cards according to the information recorded at said one or more databases, providing instructions to said line cards regarding the data that is allowed to be transmitted therefrom, establishing a physical array of connections in said switch fabric to allow said transmission, and updating said one or more databases at said switch fabric accordingly, wherein said updating of the one or more databases occurs before said transmission of data from the input line cards takes place, such that the updated information stored at said one or more databases reflects the status of queues which are expected to form at said input line cards following the transmission of data therefrom.

### FIELD OF THE INVENTION

The present invention relates to the field of communication networks. Particularly, the invention provides a method and apparatus for improving the transmission of data between line cards in distributed network switching systems.

### BACKGROUND OF THE INVENTION

A network switching system, also known in the art as a switch or router, comprises line cards, which are at the interface to the communication data lines, and a switch fabric coupled thereto, for optimally controlling the transmission of data between said line cards, such that the data received at an input line card will be forwarded, according to the destination assigned thereto, to the correct output line card. A typical scheduler-based switch fabric generally comprises a scheduler, for determining an array of connections between the line cards, according to the traffic characteristics, and a switching element, known as the cross-connect unit, where the internal physical links are actually established, thereby allowing the transmission of data between the line cards, according to the matching configuration selected by the scheduler.

Briefly, the transmission of data packets within the network switching system may be carried out as follows. Data packets received and accumulated at the input line cards are arranged according to known queuing procedures. The characteristics of the queues of the data packets that have arrived at the input line cards and are waiting to be transmitted therefrom are periodically reported to the switch fabric, where said characteristics are processed by the scheduler, according to methods known in the art, to generate an optimal array of matches of input line cards and output line cards. The scheduler forwards grant messages to the line cards, authorizing the transmission of data packets therebetween according to the array of matches established by said scheduler.

Due to practical and technical considerations, such as power distribution, space limitations and protocol requirements, there sometimes exists a need for causing a physical separation of the line cards and the switch fabric. A network switching system, wherein the line cards and the switch fabric are placed at different locations, is known in the art as a “distributed network switching system”. However, the physical separation between the line cards and the fabric unit introduces an unavoidable delay in the transmission of the data within the distributed switching system, wherein said delay results from the following contributory components:

Δₐ—A delay associated with the delivery of reports from the line cards to the switch fabric, regarding the queues of data packets that have arrived at each line card and are waiting to be transmitted therefrom;

Δ_{b}—A delay associated with the delivery of grant messages from the switch fabric to the line cards, authorizing the transmission of data packets from the input line cards to their destination.

Δ_{c}—A delay associated with the delivery of the data packets from the input line cards, to the switching element placed at the switch fabric; and

Δ_{d}—A delay associated with the delivery of the data packets from the switching element placed at the switch fabric, to the output line cards.

It may be appreciated that the matching procedure utilized by the scheduler, in order to optimally determine, at any given time, which input line cards are authorized to transfer data packets to their destinations, critically depends on the information provided by said input line cards to the scheduler. In the event that the information submitted to the scheduler fails to adequately reflect the actual status of the queues of data packets that need to be transmitted from the line cards, due to the above mentioned delays designated Δₐ and Δ_{b}, the quality of the matching policy selected by the scheduler may be severely affected.

The art has suggested a few schemes for controlling the traffic within distributed systems. For example, U.S. Pat. No. 6,285,679 describes a distributed router wherein the central switch fabric is replaced by a plurality of distributed subunits, each of which is located within a line node. The routing through the system described in U.S. Pat. No. 6,285,679 is accomplished via hops between said array of switch fabrics.

U.S. 2001/0026558 discloses a distributed scheduling system based on a distributed scheduling architecture, according to which each line card is provided with a local scheduler communicating directly with the schedulers placed in other line cards.

U.S. Pat. No. 6,345,040 describes a method and apparatus for constructing a distributed scheduler, wherein each output line card is provided with a local scheduler. Incoming data is buffered in the input line cards using buffer management method known in the art as “credit based”.

It is an object of the present invention to provide a distributed network switching system utilizing a highly effective switching management scheme, for effectively transmitting data packets within said system.

It is another object of the present invention to provide a distributed network switching system, which, although based on the use of a central scheduler and distant line cards, successfully overcomes problems associated with communication delays attributed to such physical separation.

It is another object of the present invention to provide a method and apparatus for transmitting data packets within a distributed network switching system, wherein the effect of the physical separation within the system on the quality of computational routing processes conducted thereby, is significantly minimized.

### SUMMARY OF THE INVENTION

The present invention provides a method for transmitting data between line cards in a distributed network switching system, through a switch fabric which is separated from said line cards, said method comprising receiving at said switch fabric information regarding queues of data packets that have arrived at said line cards and are waiting to be transmitted therefrom, recording said information at one or more databases located in said switch fabric, computing in said switch fabric a suitable array of connections between said line cards according to the information recorded at said one or more databases, providing instructions to said line cards regarding the data that is allowed to be transmitted therefrom, establishing a physical array of connections in said switch fabric to allow said transmission, and updating said one or more databases at said switch fabric accordingly, wherein said updating of the one or more databases occurs before said transmission of data from the line cards takes place, such that the updated information stored at said one or more databases reflects the status of queues which are expected to form at said line cards following the transmission of data therefrom.

The term “distributed network switching system”, as used herein, encompasses all network switching systems wherein the line cards are physically separated from the switch fabric, and particularly those systems wherein the distance between the line cards and the switch fabric is such that the following condition is satisfied:

min TS<max{Δₐ, Δ_{b}, Δ_{c}, Δ_{d}}

wherein TS denotes the period of time for which an array of connections between the line cards is provided by the switch fabric, following which said array of connections is replaced by another, and Δₐ, Δ_{b}, Δ_{c}, Δ_{d} are as defined above. This period of time is hereinafter denoted “time slot”.

According to a preferred embodiment of the invention, the receipt of information at the switch fabric is effected by transmitting said information from the line card following the arrival of new data packets thereto and arranging said data packets in queues, wherein said arranging comprises grouping said data packets according to destination ports and quality of service classes assigned thereto, such that each of the queues generated in said input line card may be defined in terms of a distinct destination port and a distinct classification derived from quality of service demands, and updating, at each line card, a local record regarding the status of queues of data packets arriving thereto and waiting to be transmitted therefrom.

The term “quality of service classes”, or “quality of service demands” as used herein, refers to transmission features, such as latency and bandwidth, assigned to the data packets, such that said data packets are served by the distributed network switching system according to these features.

According to a preferred embodiment of the invention, the information transmitted by each line card to the switch fabric comprises parameters which describe the status of the queues of data packets that have arrived at said line cards and are waiting to be transmitted therefrom, wherein said parameters are provided either in the form of their updated, accumulative values resulting from the arrival of new data packets at said line card, or in the form of the differences between said updated, accumulative values and the values of said parameters prior to said arrival.

According to a preferred embodiment of the invention, the information received at the switch fabric regarding queues of data packets that have arrived at the line cards and are waiting to be transmitted therefrom is recorded at said switch fabric in a plurality of databases, each of which corresponds to a single line card.

According to a preferred embodiment of the present invention, the array of connections between the line cards is provided by the switch fabric for a given period of time (time slot, as defined above), following which said array of connections is replaced by another, wherein said time slot is used to define a quasi-time unit that is used by the distributed switching system to synchronize operations within the system, such that the instructions sent by the switch fabric to the line cards include notification regarding the time at which the data packets transmitted therefrom should arrive at the switching unit placed at the switch fabric, the time being defined in said quasi-time units.

In another aspect, the present invention is related to a distributed network switching system comprising a plurality of line cards and a switch fabric provided with a scheduler and a switching element, wherein each of said line cards includes a traffic control module (15) coupled to a corresponding traffic control module (18) placed at the switch fabric and interfacing with said scheduler, said modules being designated Line Card Node and Fabric Node, respectively, wherein said Line Card Node comprises input data buffer (20), where newly arrived data packets, that need to be transmitted from the line card, are arranged in queues; arrival inspection unit (21) coupled to said buffer, for characterizing each queue by means of suitable parameters, and communicating said parameters to said Fabric Node; updated record (23) for storing said parameters; a departure controller (24) for receiving instructions from the Fabric Node in relation to data packets that are allowed to be transmitted from the Line Card Node, and wherein said Fabric Node comprises traffic data receiver (30) coupled to said arrival inspection unit (21), for receiving therefrom said parameters; a local database (31) for maintaining said parameters, which parameters are used by the scheduler (13) for running its computational algorithm; and departure controller (34) interfacing with said scheduler, for communicating with the departure controller (24) placed at the Line Card Node, and for updating the parameters stored at said local database (31).

In a preferred embodiment of the distributed network switching system according to the invention, the line cards, the switching element, the Fabric Nodes and the scheduler interfacing therewith are provided with means for synchronizing operations within the system.

All the above and other characteristics and advantages of the present invention will be further understood from the following illustrative and non-limitative examples of preferred embodiments thereof.

### IN THE DRAWINGS

FIG. 1 provides a general view of a distributed network switching system according to the invention.

FIG. 2 illustrates the operation of a traffic control module placed in the line card according to the present invention.

FIG. 3 illustrates the operation of a traffic control module placed in the switch fabric according to the present invention.

FIG. 4 illustrates the operation of the distributed network switching system according to the invention under pipeline management regime.

### DETAILED DESCRIPTION OF PREFERRED EMBODIMENTS

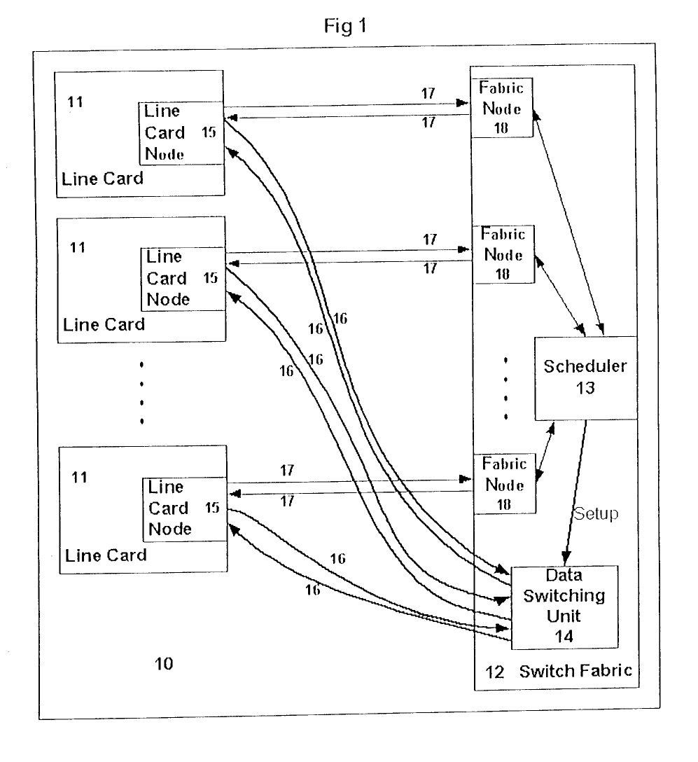

FIG. 1 schematically illustrates a preferred embodiment of the distributed network switching system 10 according to the present invention. The switching system comprises p line cards 11, wherein p is an integer number. Optionally, each line card may operate as a bi-directional link, that is, it may function both as an input port and as an output port. The line cards are interlinked by means of a switch fabric 12, which contains a scheduler 13 for processing information in relation to the queues of data packets that have arrived at said line cards and are waiting to be transmitted therefrom, whereupon an optimal matching configuration defining which queues are allowed to transmit their data packets is computed and established by said scheduler. The data switching unit 14, also known in the art as cross point switch or crossbar, sets the required array of physical connections between input and output line cards, for allowing the data transmission in accordance with the matching configuration selected by the scheduler 13.

As shown in the figure, according to the present invention, each line card 11 comprises a control module 15, which is hereinafter referred to as the Line Card Node. Each Line Card Node is physically coupled, by means of appropriate media (16, 17) such as optical fibers or electrical wires, to the switch fabric 12. Numeral 16 designates the data link, connecting the line card and the switching element 14, said data link serving to transfer data packets arriving at said line card to their destination, through the switching element 14. The data link may be physically separated from, or unified with, the control link 17, which is used to couple the Line Card Node 15 with a corresponding control module 18 located at the switch fabric, said control module being hereinafter referred to as the Fabric Node. The number of the Fabric Nodes may be equal to the number of said Line Card Nodes, as shown in the figure for the purpose of illustration. However, this is a matter of architecture, the only requirement according to the present invention being that the Fabric Node(s) will receive the required information from all Line Card Nodes, and will be able to forward suitable transmission instructions thereto, as explained in detail below.

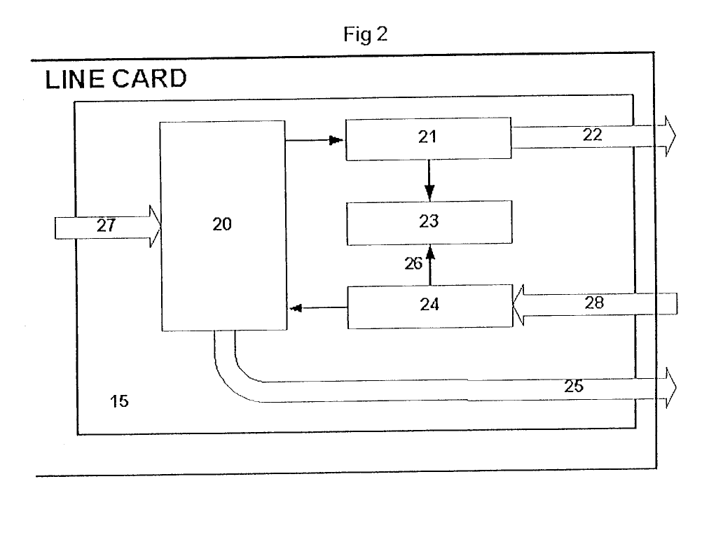

FIG. 2 schematically illustrates the components and operation of the Line Card Node 15 according to the present invention. Briefly, the Line Card Node comprises input data buffer (20), where newly arrived data packets (27) that need to be transmitted from the line card, are arranged in queues, according to methods explained below. Arrival inspection unit (21) derives from said queues predetermined parameter(s), which parameters are sufficient to characterize the status of said queues, in order to provide (22) to the corresponding Fabric Node at the switch fabric, information regarding the status of said queues, and to maintain an updated record (23) of the status of queues of data packets that are awaiting transmission from the line card. A departure controller (24) receives instructions (28) from the Fabric Node in relation to data packets that are allowed to be transmitted from the Line Card, whereupon said departure controller instructs the buffer (20) to transmit (25) the data to the switching element accordingly, and updates (26) the record (23) of the status of queues of data packets. These operations shall now be described in more detail.

Data packets, arriving at the distributed network switching systems from a network high speed point-to-point link are received at the line card 15, following which said data packets are arranged in queues in buffer 20 according to methods and algorithms which are well known in the art. Preferably, a method known as Virtual Output Queuing is used for this purpose, wherein the data packets are primarily grouped, at each input line card, according to their destination ports, and wherein said data packets, at each of the queues generated by said grouping, are further classified into distinct classes, wherein each of said classes is characterized by specific demands of quality of service, such as latency allowed. Accordingly, each queue may be conveniently denoted Qᵢⱼ^{m}, wherein m identifies the input line card, i designates the destination line card and j designates the service class.

The principles of the Virtual Output Queuing method are described, for example, by Chao et al. [“Broadband Packet Switching Technologies”, John Wiley & Sons, 2001], which is incorporated herein entirely by reference. It is to be noted, however, that any suitable queuing algorithm may be used according to the present invention for arranging the data packets received at the line cards in queues. For example, one such algorithm is known in the art as Input Queuing.

Having completed the queuing of newly received data packets at the buffer 20, the arrival inspection unit 21 of line card m calculates, for each queue Qᵢⱼ^{m} stored at said buffer, the values of one or more pre-determined parameters, which parameters may sufficiently characterize the status of said queues, such that the scheduler 13 at the switch fabric 12, upon receipt of said parameter(s), may generate a suitable array of connections between the line cards, as will be described hereinbelow. Thus, the identity of parameter(s) that need to be transmitted by the arrival inspection unit 21 to the Fabric Node are pre-determined according to the computational algorithm employed by the scheduler 13 for calculating the optimal array of connections between the line cards. Most of the computational algorithms known in the art, as discussed below, require one of said parameters to define the occupancy of the queue Qᵢⱼ^{m}, that is, the number of data packets occupying the queue Qᵢⱼ^{m}. Hereinafter, the group of parameters characterizing the status of a queue Qᵢⱼ^{m} is denoted ^{l}Ω(Qᵢⱼ^{m}), wherein l=1, 2, . . . , r, r being the total number of parameters necessary to characterize the status of the queue. As shown in FIG. 2, the Line Card Node 15 comprises a local record 23 for recording said group of parameters ^{l}Ω(Qᵢⱼ^{m}), such that the status of all the queues of data packets that need to be transmitted from the buffer 20 is fully described by said record 23.

According to one embodiment of the invention, each of the parameters in the group ^{l}Ω(Qᵢⱼ^{m}) is transmitted from the input Line Card Node m to the switch fabric in the form of its updated, accumulative value obtained following the arrival of data packets to the line card m, said value being denoted ^{l}Ω(Qᵢⱼ^{m})_{following arrival}. Alternatively, the transmitted parameter is given in terms of the difference between the value of said parameter prior to the arrival of new data packets, said value being denoted ^{l}Ω(Qᵢⱼ^{m})_{before arrival}, and the value of said parameter following said arrival, ^{l}Ω(Qᵢⱼ^{m})_{following arrival}, wherein said difference is hereinafter designated Δ[^{l}Ω(Qᵢⱼ^{m})]. Thus, according to this embodiment of the invention, the Line Card Node in notifies, by means of the arrival inspector 21, the corresponding Fabric Node of the number of data packets that were recently added to a particular queue Qᵢⱼ^{m}, rather than reporting to said Fabric Node of the total, accumulative number of data packets currently occupying said queue. The use of such a differential in place of an accumulative parameter in the reports transmitted from the Line Card Node to the corresponding Fabric node constitutes an important advantage according to the present invention, since the number of data packets added to a particular queue is not affected by communication delays inherent to a distributed switching system. Furthermore, messages forwarded by the Line Card Node reporting only the additions occurring at a given queue may require less bandwidth, and consequently, these messages may be more easily and effectively processed at the switch fabric. It should be noted, however, that the periodic transmission of the total, accumulative parameters, ^{l}Ω(Qᵢⱼ^{m})_{following arrival}, is entirely applicable.

As shown in FIG. 2, the Line Card Node comprises a departure controller 24, which receives from the switch fabric accurate instructions identifying the queues that are allowed to transmit data packets, and the exact number of data packets to be sent to their destination through the switching element placed in the switch fabric. The departure controller 24 carries out these instructions, notifying the locally stored queues at buffer 20 to deliver their data packets accordingly. The departure controller 24 updates the local record 23 located at the Line Card Node, said record maintaining the parameters ^{l}Ω(Qᵢⱼ^{m}) of the queues of data packets that need to be transmitted from the Line Card.

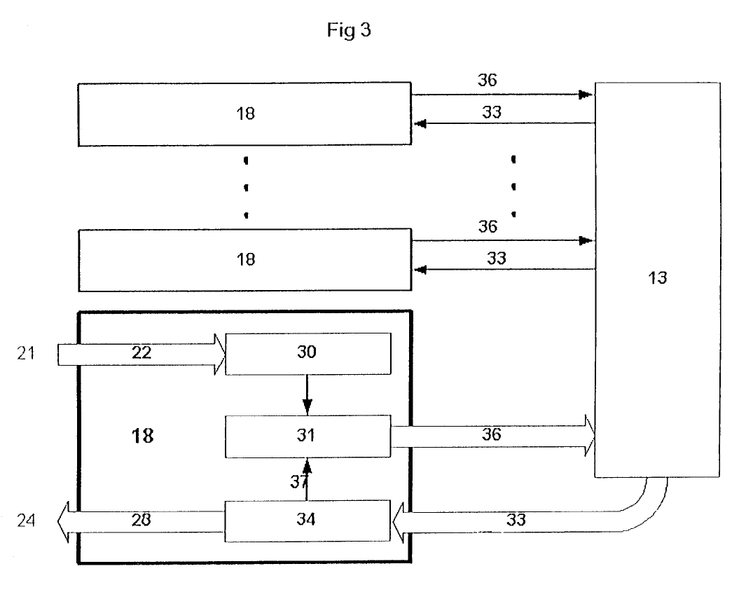

FIG. 3 schematically illustrates the components and operation of the Fabric Node 18 according to the present invention. The Fabric Node 18 comprises traffic data receiver 30, for receiving (22) from the corresponding arrival inspection unit 21, located at the distant line card, information, regarding the status of queues of data packets that need to be transmitted from said line card, including information related to the occupancy of said queues, as explained above.

The Fabric Node 18 records the information received from the corresponding Line Card Node at a local database 31, maintaining a group of parameters ^{l}Ω(Qᵢⱼ^{m}) which are sufficient to characterize the status of any queue Qᵢⱼ^{m} in the corresponding Line Card Node coupled thereto, such that the scheduler 13 may use (36) the locally-stored parameters ^{l}Ω(Qᵢⱼ^{m}) for running its computational algorithm in order to generate an optimal array of connections between the line cards. Suitable algorithms which may be processed by the scheduler for attaining this purpose are well known in the art, and are described, for example, in international publication no. WO 01/33778 or in U.S. Pat. No. 5,517,495.

Having completed the computational process, the scheduler provides 33 the Fabric Node with well-defined instructions regarding the data packets that are allowed to be transmitted from the specific line card coupled thereto.

Specifically, the instructions provided by the scheduler comprise identification of one or more queues Qᵢⱼ^{m}, for which transfer of data packets is permitted, and the exact number of data cells to be transmitted from each of said one or more queues. These instructions are forwarded (28) to the departure controller (24) located within the corresponding Line Card Node by means of a Fabric Node departure controller 34, located within the Fabric Node, wherein said Fabric Node departure controller 34 also updates (37) the local database (31) located at the Fabric Node accordingly, without waiting for the data transfer from the card line m to occur, such that the group of parameters ^{l}Ω(Qᵢⱼ^{m}) stored at said local database 31 reflects the status of queues Qᵢⱼ^{m} which are expected to form at line card m following the transmission of data therefrom.

It may be appreciated that according to the present invention, any arrival of data packets at a given line card m, and any expected transmission of data packets therefrom, said transmission being determined by the scheduler, are reflected by the group of parameters Qᵢⱼ^{m} stored in a database at Fabric Node in placed in the central switch fabric. The location of these databases within the switch fabric, that is, in close proximity to the scheduler, allows the scheduling algorithm to use the locally-stored, updated parameters Qᵢⱼ^{m} for carrying out the computational procedures, in place of relying on the record of the status of queues at the remote line cards.

In certain distributed network switching systems, the instructions forwarded by the scheduler to a given line card in may also comprise identification of another line card s, from which said line card in is expected to receive data packets according to the array of matches established the scheduler. Such information is particularly required in optically-based distributed network switching systems.

The method according to the present invention, for transmitting data between line cards in a distributed network switching system, through a switch fabric which is separated from said line cards, as described in detail above, is preferably practiced under pipeline scheduling regime. The various components of the distributed switching system measure time in terms of a quasi-time unit (‘time slot’), such that the operations within the system may be synchronized according to this uniform time reference. The duration of the quasi-time unit equals the period during which the physical array of connections established by the switching element (the cross-connect unit located at the switch fabric) is held fixed, allowing data transmission between the line cards. At the end of the time slot, the array of connection provided by the cross-connect unit is replaced by another, according to the matching configuration selected by the scheduler. It should be noted, however, that the synchronization of the system is not limited to the duration of the time slot (i.e., one complete quasi-time unit), as the system may initiate operations at time points other than at the beginning of a time slot.

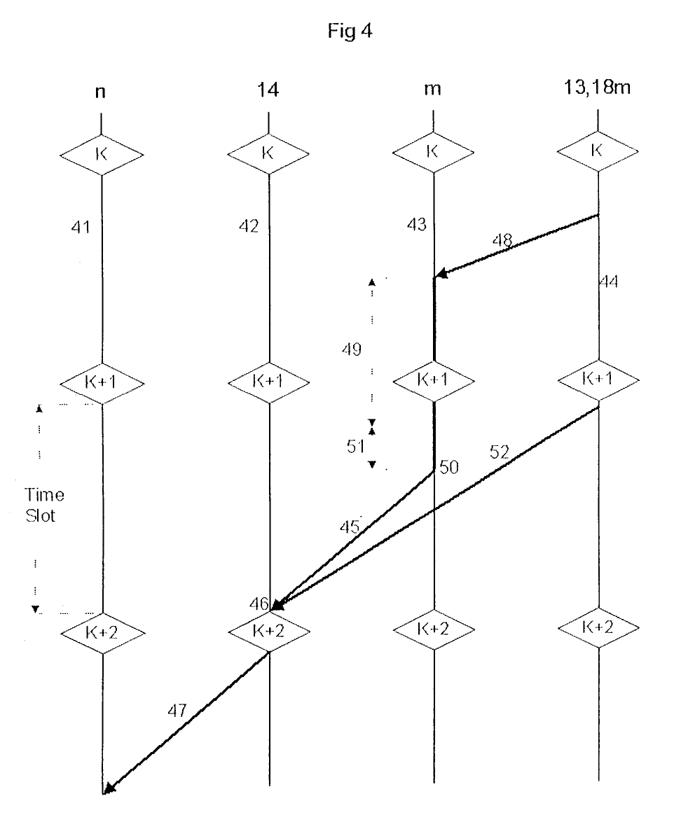

FIG. 4 schematically shows the transfer of data packets from line card m to line card n, through the remote data switching unit 14 (the crossbar), under the pipeline scheduling management according to the invention. The transmitting line card m, the receiving line card n, the scheduler 13 (and the Fabric Node 18m comprised therein, which is coupled to line card m), and the switching element 14 are all provided with suitable counters for measuring time in time slot units. For the purpose of illustration, the figure associates a time axis (41, 42, 43 and 44) to each of the aforementioned components, thus relating the traffic conducted within the distributed system to said time axes. As can be seen, each time axis is defined in terms of time slots (k, k+1, k+2 . . . ). For the purpose of simplification, the duration of the time slot is preferably constant, although this is not mandatory.

Under the pipeline scheduling management, data packets transmitted from line card m (45) must timely arrive at the data switching unit (46), at the beginning of the time slot during which the array of physical connections fixed by said data switching unit is suitable for transferring (47) said data packets to their destination, that is, to line card n. To this end, the instructions (48) sent by the Fabric Node 18m to the line card m coupled thereto, regarding the data packets that are allowed to be transmitted therefrom, also include a notification regarding the time slot at which the data packets should arrive at the data switching unit 14, such that the line card m, following the processing of said instructions during time interval designated 49, will initiate the transmission of data packets therefrom at appropriate time (50), deferring said transmission (51), if necessary, to assure that said data packets arrive at the data switching unit 14 exactly on time (46, i.e., at the beginning of the time slot k+2). In addition, the scheduler 13 notifies the data switching unit 14 in relation to the physical array of connections that needs to be established thereby at each time slot (52).

It may be appreciated that in order to handle the traffic within the distributed network switching system according to the invention, as described above, the delay associated with the delivery of instructions from the Fabric Node 18m to line card m (represented by the slope of arrow 48), the time required to process said instructions at the Line Card Node (49) and the delay associated with the delivery of data packets from the line card m to the data switching unit 14 (represented by the slope of arrow 45) must all be known. These delays are calculated by the system, as described below, and are taken into account by the Fabric Node 18m, which sends the instructions to the corresponding line card m well in advance before the transmission of the data packets from said line card is due, and by said line card m, which timely initiates (50) said transmission, thus assuring that the data packets are received by the data switching unit at the correct time slot (46, time slot k+2).

The aforementioned delays may be calculated as follows. The fabric Node forwards a message to the corresponding Line Card Node, which message is sent back to the Fabric Node. The message includes the following time parameters:

The time recorded at the Fabric Node upon forwarding the message (T₁);

Delay within the Line Card Node, T₂ (that is, the time interval between receipt of said message at the Line Card Node and its delivery to the Fabric Node); and

The time recorded at the Fabric Node upon receipt of the message (T₃).

The delay Δ_{A} attributed to the physical separation between the Line Card Node and the Fabric Node may be readily calculated using the aforementioned time parameters:

Δ_{A}=(T₃−(T₁+T₂)/2.

The Fabric node periodically sends synchronization messages (not shown) to the Line Card Node, to enable said Line Card Node to synchronize its internal time slot counter, thus assuring that the Line Card Node and the Fabric Node (and the scheduler) refer to a uniform time scale. To this end, the synchronization message includes the following time parameters:

The value of the time slot counter at the Fabric Node (T₄);

The time interval between the beginning of said time slot to the delivery of the synchronization message (T₅).

Upon receipt of the synchronization message, the Line Card Node records the time of receipt. Based on the delay previously calculated, the Line Card Node synchronizes its “internal clock”, that is, its internal time slot counter TSCLCN, using the following formula:

$${TSC}_{LCN} = {T}_{4} + \frac{{T}_{5} + {Δ}_{A} + {T}_{6}}{TS}$$

wherein T₄, T₅ and Δ_{A} are as defined above, T₆ is the time interval between the receipt of the synchronization message at the line card and its procession and TS is the duration of a time slot.

It should be noted that the above calculations are illustrated for the case wherein the scheduler 13 and the crossbar 14 are placed at the same physical location. In the event that the scheduler 13 and the crossbar 14 are physically separated, the above calculations may be easily modified, taking into account delays attributed to said separation.

While specific embodiments of the invention have been described for the purpose of illustration, it will be understood that the invention may be carried out in practice by skilled persons with many modifications, variations and adaptations, without departing from its spirit or exceeding the scope of the claims.

1. A method for transmitting data between line cards in a distributed network switching system, through a switch fabric which is separated from said line cards, said method comprising receiving at said switch fabric information regarding queues of data packets that have arrived at said line cards and are waiting to be transmitted therefrom, recording said information at one or more databases located in said switch fabric, computing in said switch fabric a suitable array of connections between said line cards according to the information recorded at said one or more databases, providing instructions to said line cards regarding the data that is allowed to be transmitted therefrom, establishing a physical array of connections in said switch fabric to allow said transmission, and updating said one or more databases at said switch fabric accordingly, wherein said updating of the one or more databases occurs before said transmission of data from the input line cards takes place, such that the updated information stored at said one or more databases reflects the status of queues which are expected to form at said input line cards following the transmission of data therefrom.

2. A method according claim 1, wherein the receipt of information at the switch fabric is effected by transmitting said information from the line cards following the arrival of new data packets thereto and arranging said data packets in queues, wherein said arranging comprises grouping said data packets according to destination ports and quality of service classes assigned thereto, such that each of the queues generated in said line cards may be defined in terms of a distinct destination port and a distinct classification derived from quality of service demands, and updating, at each line card, a local record regarding the status of queues of data packets arriving thereto and waiting to be transmitted therefrom.

3. A method according to claim 2, wherein the information transmitted by each line card to the switch fabric comprises parameters which describe the status of the queues of data packets that have arrived at said line cards, wherein said parameters are provided either in the form of their updated, accumulative values resulting from the arrival of new data packets at said line card, or in the form of the differences between said updated, accumulative values and the values of said parameters prior to said arrival.

4. A method according to claim 1, 2 or 3, wherein the information received at the switch fabric regarding queues of data packets that have arrived at the line cards and are waiting to be transmitted therefrom is recorded at said switch fabric in a plurality of databases, each of which corresponds to a single line card.

5. A method according to claim 1, wherein the physical array of connections for allowing the transmission of data between the line cards is established in the switch fabric for a given period of time, denoted time slot, following which said physical array of connections is replaced by another, wherein said time slot is used to define a quasi-time unit that is used by the distributed switching system to synchronize operations within the system.

6. A method according to claim 5, wherein the instructions sent by the switch fabric to the input line cards include notification regarding the time slot at which the data packets transmitted therefrom should arrive at the switch fabric.

7. A distributed network switching system comprising a plurality of line cards 11 and a switch fabric 12 provided with a scheduler 13 and a data switching unit 14, wherein each of said line cards includes a traffic control module 15 coupled to a corresponding traffic control module 18 placed at the switch fabric and interfacing with said scheduler, said modules being designated Line Card Node and Fabric Node, respectively, wherein said Line Card Node comprises input data buffer (20), where newly arrived data packets, that need to be transmitted from the line card, are arranged in queues; arrival inspection unit (21) coupled to said buffer, for characterizing each queue by means of suitable parameters, and communicating said parameters to said Fabric Node; updated record (23) for storing said parameters; a departure controller (24) for receiving instructions from the Fabric Node in relation to data packets that are allowed to be transmitted from the Line Card Node, and wherein said Fabric Node comprises traffic data receiver 30 coupled to said arrival inspection unit 21, for receiving therefrom said parameters; a local database 31 for maintaining said parameters, which parameters are used by the scheduler 13 for running its computational algorithm; and Fabric Node departure controller 34 located within the Fabric Node and interfacing with said scheduler, for communicating with the departure controller 24 placed at the Line Card Node, and for updating the parameters stored at said local database 31.

8. A distributed network switching system according to claim 7, wherein the line cards, the data switching unit, the scheduler and the Fabric Nodes are provided with means for synchronizing operations within the system.
